(19) United States
(12) Patent Application Publication
(10) Pub. No.: US 2014/0214467 A1
(43) Pub. Date: Jul. 31, 2014

(54) TASK CROWDSOURCING WITHIN AN ENTERPRISE

(71) Applicant: HEWLETT-PACKARD DEVELOPMENT COMPANY, L.P., Houston, TX (US)

(72) Inventors: Sitaram Asur, Mountain View, CA (US); Anupriya Ankolekar, Sunnyvale, CA (US); Bernardo Huberman, Palo Alto, CA (US)

(73) Assignee: Hewlett-Packard Development Company, L.P., Houston, TX (US)

(21) Appl. No.: 13/756,156

(22) Filed: Jan. 31, 2013

(51) Int. Cl. G06Q 10/06

(52) U.S. Cl. CPC G06Q 10/063112
USPC 705/7.14

(57) ABSTRACT

Systems, methods, and machine-readable and executable instructions are provided for crowdsourcing a task within an enterprise. Crowdsourcing a task within an enterprise can include receiving features of a number of tasks, receiving features of a number of users, comparing a portion of the features of the number of tasks with a portion of the features of the number of users, and recommending tasks for particular users based on the comparison.

### BACKGROUND

Crowdsourcing is a distributed problem-solving and production model. Crowdsourcing has developed as a way to outsource tasks to distributed groups of people. Crowdsourcing generally includes outsourcing a task to a large public network rather than a specific body. In crowdsourcing, a task will often be outsourced in the form of an open call for solutions. Crowdsourcing relies on distributed users or groups of users participating in task completion.

Crowdsourcing has been used for numerous projects including indexing public knowledge and solving scientific and industrial problems. More recently, crowdsourcing has assumed a strong Internet presence with many tasks being outsourced in an online environment. Online crowdsourcing allows the aggregation of a vast cross-section of people to bring their diverse efforts, knowledge and/or experience to bear on a particular task.

Crowdsourcing has limitations. One limitation is related to the quality of work that it generates. For example, crowdsourcing largely preserves the anonymity of the crowd which leads some members of the crowd to be less concerned with the quality of their work and remain unaware of the scrutiny it faces. Because individuals in the crowd are not directly accountable for their work, there is often less incentive to perform a task well.

### BRIEF DESCRIPTION OF THE DRAWINGS

FIG. 1 illustrates a diagram of an example of a system for crowdsourcing a task within an enterprise according to the present disclosure.

FIG. 2 illustrates a block diagram of an example of a method for crowdsourcing a task within an enterprise according to the present disclosure.

FIG. 3 illustrates a block diagram of an example of a system for crowdsourcing a task within an enterprise according to the present disclosure.

### DETAILED DESCRIPTION

The daily function of an enterprise (e.g. a corporation developing computer software and/or hardware) can include the completion of a multitude of tasks. The tasks may range from the mundane (e.g. coding up interviews) to the specialized (e.g. creating a user interface for a new project). The multitude of tasks can include utilizing a diversity of resources (e.g. time, expertise; material resources, etc.) to accomplish them.

Enterprises often strive to employ people with a diversity of expertise and various other characteristics to develop a large resource pool to accomplish any given task. Enterprises additionally often obtain and develop different tools and technologies with a diversity of functions to accomplish any given task.

In this manner, an enterprise develops a distributed resource pool (e.g. resources distributed over employees, divisions, geography, etc.). Enterprises can be inefficient in utilizing distributed resources to accomplish a given task. For example, an enterprise often functions in a hierarchical manner. Utilizing a hierarchical structure, an enterprise may assign a particular task to a particular employee. The task may be well aligned with the available resources of the employee. However, the task may include utilizing resources, such as time, expertise, or material resources not directly available to a particular employee performing a particular task (e.g. the resources exist distributed throughout the enterprise).

By crowdsourcing a task within an enterprise, the enterprise can utilize its distributed resources to efficiently (e.g. precisely allocating expertise through skill based matching) achieve tasks, and boosting productivity in the enterprise as a whole. Crowdsourcing a task within an enterprise allows for flexible application of enterprise resources to a task while preserving the confidential nature of the task. Furthermore, through crowdsourcing within an enterprise, the enterprise can reinforce accountability among its employees. Accountability may be reinforced through “gamification” (e.g. metrics, incentives, tokens, etc.).

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As used herein, “a” or “a number of” an element and/or feature can refer to one or more of such elements and/or features. Further, where appropriate, as used herein, “for example” and “by way of example” should be understood as abbreviations for “by way of example and not by way of limitation”.

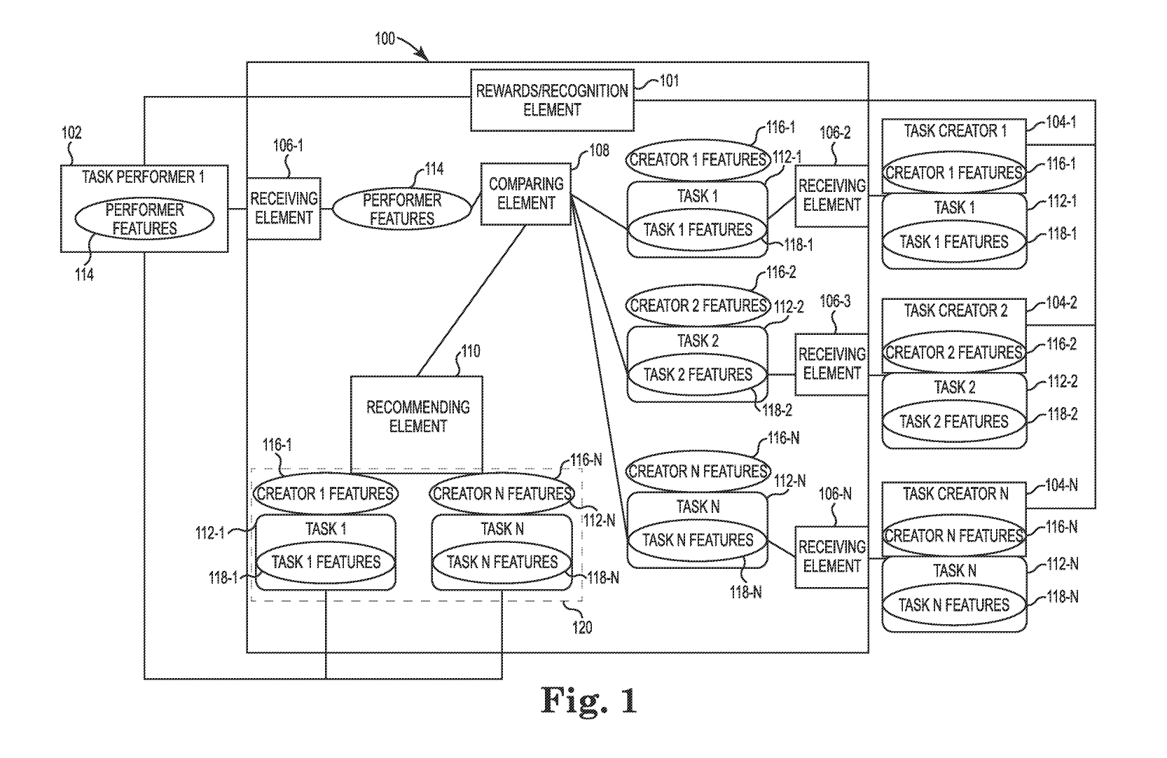

FIG. 1 illustrates a diagram of an example system 100 for crowdsourcing a task within an enterprise according to an example of the present disclosure. FIG. 1 depicts a system 100 which can include a number of users (e.g. task performer 102, task creators 104-1-104-N (hereinafter collectively referred to as 104), a number of receiving elements 106-1-106-N (hereinafter collectively referred to as 106), a comparing element 108, a rewards/recognition element 101, and a recommending element 110. The number of receiving elements 106-1-106-N, the comparing element 108, and the recommending element 110 can be a combination of hardware and machine readable medium (MRM) designed to implement their respective functions.

The number of users (e.g. 102, 104) can include a number of people. For example, the number of users (e.g. 102, 104) may represent employees of an enterprise. The number of users (e.g. 102, 104) can include only employees of an enterprise and/or related enterprises. The number of users (e.g. 102, 104) can alternatively or additionally include contractors and/or affiliates of an enterprise. Users (e.g. 102, 104) can include, for example, individual employees, groups of employees, departments of an enterprise, business groups of an enterprise, divisions of an enterprise, technology areas of an enterprise, geographical segments of an enterprise, organizational groups, virtual groups, etc.).

The users (e.g. 102, 104) can be categorized. This categorization can be based on the users' (e.g. 102, 104) position (e.g. job description, department, business group, seniority, general hierarchy, etc.) within the enterprise. For example, a user (e.g. 102, 104) can be categorized as a task performer 102 based on the user (e.g. 102) holding an employment position within the enterprise of a junior programmer. Conversely, a user (e.g. 102, 104) can be categorized as a task creator 104 based on the user (e.g. 104) holding an employment position within the enterprise of a senior department manager. Additionally or alternatively, the categorization can be based on the behavior of the user (e.g. 102, 104) within the system 100. For example, the user (e.g. 102, 104) can be categorized as a task performer 102 when, by way of example, the laser is searching for tasks (e.g. 112-1-112-N, hereinafter collectively referred to as 112) to perform. Alternatively or additionally, a user (e.g. 102, 104) can be categorized as a task creator 104 when, by way of example, the user (e.g. 104) has a task (112) for a task performer (102) to perform. Alternatively or additionally, a user (e.g. 102, 104) can be categorized as a task creator 104 when, by way of example, the user (e.g. 104) is creating a task (e.g. 112). Creating a task (e.g. 112) can include, for example, not only originating a task creation in the system 100, but also re-originating a task and/or a portion of a task within the system 100. Creating a task (e.g. 112) can include communicating the task (e.g. 112) to the receiving elements 106.

Users (e.g. 102, 104) can be further categorized. For example, users can be collectively categorized into groups or sub groups. For further example, a portion of the users may be categorized as a group having a particular expertise or range of expertise. By way of example, the grouping may be categorized based on information related to the users. This information can include features (114, 116-1-116-N, hereinafter collectively referred to as 116) of a user (e.g. any number of characteristics of a user). Additionally or alternatively, users may categorize themselves as a group. This self-categorization may be based on any determination made by the users.

The categorizations can apply to a user's behavior within the system 100 and a given user (e.g. 102, 104) can have both performer features 114 and creator features 116. For example, the system 100 can differentiate between and/or separately utilize performer features 114 and creator features 116 depending on the behavior of the user. That is, the system 100 may receive and/or utilize only the creator features of a given user when the user is behaving as a task creator and may receive and/or utilize performer features of the same user when the user is behaving as a task performer.

A task performer 102 can have a number of performer features 114. Performer features 114 can include a number of characteristics of the task performer 102. For example, performer features 114 can include features relevant to task performance within the enterprise. For example, performer features 114 can include, but are not limited to, skill sets, a number of tasks completed by the task performer 102, any groups that the task performer 102 belongs to, and/or aspects of the task performer's 102 schedule.

Skill sets within the performer features 114 can include, but are not limited to, textual descriptions of skills of the task performer 102, listings of the skills of a number of skills recognized within the system 100 possessed by the task performer 102 (which can provide a more standardized skill set listing), and/or any symbols (e.g. colors, numbers, letters, etc.) that communicate a skill. Skill sets of a task performer 102 can include a proficiency score of each task performer 102. A proficiency score can include, for example, a textual description of a given task performer's experience in a given skill. Additionally or alternatively, a proficiency score can include any symbols that communicate experience or proficiency in a given skill. In some examples, a proficiency score can be standardized across the system 100, such that a proficiency score of one user is comparable to the proficiency score of another user and/or a benchmark score.

A number of tasks completed by the task performer 102 within the performer features 114 can include, but is not limited to, a textual description of the number of tasks completed, a value representing a number of tasks completed, and or any symbols that communicate a number of tasks completed by the task performer 102.

Any groups that a task performer 102 belongs to within the performer features 114 can include, but are not limited to, a textual description, or any symbols, colors, that communicate a group to which the task performer 102 belongs.

Aspects of the task performer's 102 schedule within the performer features 114 can include, but are not limited to, a full schedule of events, a schedule of availability, a schedule of deadlines the task performer 102 must meet, and/or an employee calendar.

The performer features 114 can be received (e.g. via a number of receiving elements 106) from the task performer 102. For example, the task performer 102 can submit a survey to the system 100 with an indication of performer features 114. The survey can include textual descriptions of performer features 114 of the task performer 102 and/or selection of performer features 114 from a list of performer features 114 recognized within the system 100. For example, the performer features 114 can alternatively or additionally be received from enterprise knowledge including an employee database and/or employee records. Performer features 114 can also be received from a number of online resources (e.g. social networking sites, professional networking sites, web pages, email services, online records of any kind, etc.). Additionally, the system 100 can receive performer features 114 by compiling user features during operation of the system 100. For example, the system 100 can compile an amount of experience in a skill set, an amount of tasks completed, and/or any groups a user belongs to by keeping track of (e.g. logging and compiling) these features as they occur within the system 100. For example, the system 100 can log each time a task performer 102 performs a task and compile a list of the completed tasks and the associated features of the task.

Task creators 104 can have a number of creator features 116. As task performers 102 can have all or some of the creator features 116, the task creators 104 can also have all or some of the performer features 114. Creator features 116, additionally or alternatively to performer features 114, can include, but are not limited to, an amount of tasks that a task creator 104 has created, a number of active tasks that a task creator 104 has created, and/or a task creator's 104 availability to provide guidance on performing a particular task 112. Active tasks can include tasks 112 which are not yet assigned to a task performer 102. For example, an active task can include a task 112 that has not been selected by a task performer 102 as a task 112 that he has interest in performing and which the task creator 104, in response, has indicated is assigned to the task performer 102.

Creator features 116 can be received in the same manner as described with regard to performer features 114. For example, creator features 116 may be received via the same means as performer features 114 and from the same sources as performer features 114. For example, a creator feature 116 can be received via a receiving element 106 from a task creator 104, enterprise knowledge, and/or online resources.

A user can be categorized as a task creator 104 when creating a task 112. For example, a task 112 can include various portions of an activity. The activity can include a variety of actions related to the enterprise. For example, the action may include development of software and/or hardware for the enterprise.

A task 112 can have a number of task features 118-1-118-N (hereinafter collectively referred to as 118). Task features 118 can include any number of characteristics of the task and/or information associated with a task 112. For example, task features 118 can include, but are not limited to, a description of the task 112, a list of skills associated with task completion 112, a level of complexity of a task 112, an importance of a task 112, the deadline of a task 112, and/or an estimated amount of time to complete a task 112.

A description of a task 112 within the task features 118 can include, but is not limited to, a textual description of the task 112. The description can include figures associated with the task 112, images associated with the task 112, electronic files associated with the task 112, hyperlinks associated with the task 12, and/or templates associated with the task 112. That is, the description can include various information capable of communicating the nature of the task 112.

A list of skills associated with task completion within the task features 118 can include, but is not limited to, a list of skills applicable during completion of the task, a list of skills desired to complete the task, and/or a list of skills determined to be most advantageous in completing the task. The list of skills can be generated by, although not limited to generation by, the task creator 104, a computer algorithm, review of enterprise standards, historical review of completed tasks, and/or by any entity of the enterprise. A list of skills associated with task completion with the task features 118 can include a textual description of the skills associated with completion of the task 112. Alternatively or additionally, the list of skills associated with completion of the task 112 can be listings of a number of skills recognized within the system 100 and/or any symbols (e.g. colors, numbers, letters, etc.) that communicate a skill associated with task completion. For example, the list of skills associated with task completion can correlate to the same number of skills recognized within the system 100 within performer features 114. For example, a list of skills associated with task completion may include fluency in a particular programming language, where performer features 114 may include indications of fluency in particular programming languages. In this manner, a standard listing of skills can allow for easy direct comparison between the skills that a task performer 102 possesses and those associated with task completion without requiring without sacrificing resources interpreting semantic differences between the multiple listings.

A list of skills associated with task completion can alternatively or additionally include a proficiency score within a skill associated with task completion. The proficiency score can be, for example, a target proficiency score determined by the task creator 104 generated by, although not limited to generation by, the task creator 104, a computer algorithm, review of enterprise standards, historical review of completed tasks, and/or by any entity of the enterprise. The proficiency score can include, but is not limited to, a textual description of a desired experience in a given skill for a task performer 102 performing the task. Additionally or alternatively, a proficiency score can include any symbols communicating experience or proficiency in a given skill. In some examples, a proficiency score can be standardized across the system 100, such that a desired proficiency score is directly comparable to a task performer's 102 proficiency score and one task performer's 102 proficiency skill is directly comparable to another and/or to a set of standards defining proficiency skill levels.

A level of complexity of a task 112 within the task features 118 can include a metric of the difficulty of a given task 112. A level of complexity can include a textual description of the complexity of a task 112 and/or symbols that communicate complexity. A level of complexity can be based, for example, on the task creator's 104 assessment of the difficulty of a task 112. This assessment can be based on a number of factors. The number of factors can include the task creator's 104 professional judgment and experience, comparison to the level of complexity of prior tasks in the system 100, a comparison of the task 112 to a set of guidelines defining complexity of a task, and/or by a complexity determining algorithm accounting for a portion of the task features 118. In some examples, complexity can be standardized across the system 100, such that complexity of one task 112 can be directly compared the complexity of another (e.g. complexity of other active tasks, complexity of completed tasks, complexity of hypothetical tasks with an accepted scoring convention applied) on the basis of this metric.

An importance of a task 112 within the task features 118 can include a metric of the value and/or exigency attached to a task 112. An importance can include, but is not limited to, a textual description of the importance and/or symbols that communicate importance. The importance can be determined by a number of factors. The number of factors can include a determination of the task creator 104 based on the task creator's professional judgment and experience, comparison to the level of importance of prior tasks in the system 100, a comparison of the task 112 to a set of guidelines defining the importance of a task, and/or by an importance determining algorithm utilizing a portion of the task features 118. Alternatively and or additionally, importance of a task 112 can be determined by enterprise actors including enterprise leadership, enterprise marketing departments, and/or enterprise investors. In some examples, importance can be standardized across the system 100, such that the importance of one task can be directly compared to the importance of another (e.g. importance of other active tasks, importance of completed tasks, importance of hypothetical tasks with an accepted scoring convention applied) on the basis of this metric.

A deadline of a task 112 within the task features 118 can be based on a deadline by which the task 112 must be completed. For example, a deadline can be a specific, date, quarter, year, fiscal year, and/or any measure of time by which the task 112 must be completed. The deadline can, for example, be determined by the task creator 104. Alternatively or additionally, the deadline can be determined by employees of the enterprise other than the task creator 104. The deadline can additionally or alternatively be determined by entities outside of the enterprise. Before a task 112 is assigned to a task performer 102, it can be classified as an active task. Once a task 112 has been assigned to a task performer 102, it can be classified as non-active. If a deadline for a task 112 has passed without assignment to a task performer 102, the task 112 can be classified as non-active. If a task 112 becomes non-active due to the deadline passing without assignment, it can revert back to the task creator 104. Reverting back can include removing the task 112 from the system and/or transmitting the task 112 and/or a message associated with the task to the task creator 104.

An estimated amount of time to complete a task 112 within the task features 118 can include an estimate of the time necessary to complete a task 112 based on the features of the task. The estimate can be an estimate by the task creator 104 and/or any other entity associated with the task. The estimate can be based on data about similar tasks. For example, the estimate can be based on the actual time to complete previous tasks in the system 100 with similar task features to the current task features 118.

Task features 118 can be received by the system 100 from a number of sources. For example, task features 118 can be received from the task creator 104. Task features 118 can be received from the task itself 112. For example, software can analyze the task and/or information associated with the task, which can be submitted by the task creator 104, and extract task features 118 from the task. Task features 118 can additionally or alternatively be received from entities other than the task creator 104. Task features 118 can be received from various enterprise databases of tasks and/or any online resource associated with the task.

In the system 100 for crowdsourcing a task within an enterprise illustrated in the diagram of FIG. 1, task features 118 can be received along with the task 112 from the task creator 104 at the receiving elements 106. Creator features 116 can be received along with the received task features 118 and the task 112 at the receiving elements 106.

The embodiments illustrated in FIG. 1 depict the performer features 114 can be received at receiving element 106-1. FIG. 1 illustrates that the performer features 114 can be received at receiving element 106-1 from the task performer 102.

The performer features 114, the creator features 116, the tasks 112, and/or the task features 118 can be stored in the system 100. For example, the creator features 116, the tasks 112, and the task features 118 can be stored in the same and/or separate databases of the system 100.

All information and/or data received by the system 100 can be displayed (e.g. as a marketplace) to users (e.g. 102, 104) of the system 100. A marketplace can include a searchable listing within an enterprise. For example, performer features 114, creator features 116, tasks 112, and/or task features can displayed in a user interface to task performers 102 and/or task creators 104. Displaying a marketplace can include displaying lists of active tasks 112, creator features 116 associated with the creator 104 of each task 112, and/or task features 118 of each task 112 to task a performer 102. Additionally or alternatively, displaying a marketplace can include displaying a list of task performers 102 and task performer features 114 to a task creator 104.

The marketplace can be displayed to users based on password access requirements. The marketplace can, alternatively or additionally, be displayed to users based on information associated with the users. For example, a user may have access to the marketplace display, and/or portions of the marketplace display based on their position within the enterprise.

Users of the system 100 can review the displayed marketplace. Reviewing the displayed marketplace can include reviewing lists of data received by the system 100. Reviewing the displayed marketplace can further include selecting data, and/or portions of data received by the system 100. Selecting data can include selecting an active task 112 to perform and/or a task performer 102 to perform a task 112.

The performer features 114 can be compared to the creator features 116, the tasks 112, and/or the task features 118 by a comparing element 108. The comparing element 108 can conduct the comparison based on triggers (e.g. events in the system which lead to a comparison request). For example, the comparison element 108 may conduct the comparison based on receiving the performer features 114, the creator features 116, the tasks 112, and/or the task features 118 into the system 100. The comparison element 108 may store or cause to be stored the results of the comparison. Thereafter, the results of the comparison can be accessed by users (e.g. 102, 104) of the system 100.

The comparing element 108 may conduct the comparison based on a search request of a user. For example, the task performer 102 conducts a search of available tasks 112 in the system 100. The comparing element 108 can be triggered to conduct comparison of the performer features 114 to the creator features 116, the tasks 112, and/or the task features 118. Alternatively or additionally, the task creator 104 can conduct a search for available task performers 102 to perform a task 112, triggering comparing unit 108 to compare the creator features 116, the tasks 112, and/or the task features 118 to the performer features 114 of available task performers 102.

The function of the comparing element 108 can include comparing any information in the system 100 to any other information in the system 100. Comparing element 108 can, for example, compare a portion of the features 118 of the number of tasks with a portion of the features 114 of the number of users. For example, the comparing element 108 can compare any portion of the task features 118 to a matching and/or common portion of the performer features 114, or vice versa. The matching and/or common features can include features that are identical or those that are complimentary. For example, the comparing element 108 can be triggered by a task performer 102 conducting a search of available tasks 112 in the system 100 and can compare the performer features 114 such as skill sets with task features 118 of available tasks 112 such as a lists of skills associated with task completion and a level of complexity of a task. Additionally or alternatively, the comparing element 108 can be triggered by a task creator 104 conducting a search of available task performers 102 to perform a task 112. As a result, the comparing element 108 can compare task features 118 of the task 112 such as a list of skills associated with task completion and a level of complexity of a task with performer features 114 such as skill sets of available task performers 102. Alternatively or additionally, the comparing element 108 can simply present a user with a list of available tasks and/or task performers so that the user can perform the comparison.

Upon completion of comparison by the comparing element 108, the recommending element 110 may make a recommendation 120 based on the comparison. For example, recommending element 108 can recommend tasks (e.g. 112-1, 112-N) for a particular user 102 based on the comparison. Recommending based on the comparison can include recommending a task to a user, and/or a user to a task, based on matches between performer features 114 and creator features 116, the tasks 112, and/or the task features 118. Matches may include increments of identity between any portions of any features. A recommending element 108 can recommend particular tasks and/or task performers 102. Alternatively or additionally, a recommending element 108 can recommend a list of tasks (e.g. 112-1, 112-N) and/or task performers 102 arranged by increments of recommendation. The recommending element 108 can base its recommendation on input received from the comparing unit 108.

The recommending element 108 can communicate its recommendation 120 to any number of users 102, 104. For example, a recommendation 120 of recommending element 108 to user 102. The recommendation 120 can include creator features (e.g. 116-1, 116-N), tasks (e.g. 112-1, 112-N), and/or task features (e.g. 118-1, 118-N). Alternatively or additionally, the recommending element 108 can communicate its recommendation 120 to other users including the task creator (e.g. 104-1, 104-N). Communication of a recommendation 120 to a task creator 104 can additionally or alternatively include performer features 114.

The rewards/recognition element 101 can manage a user recognition scheme, rewards scheme, and or credit (e.g. virtual currency) scheme. For example, the rewards/recognition element 101 can manage gamification measures. The gamification scheme can include measures which incentivize behavior within the system 100 through the use of game mechanics and game design techniques. These measures can include measures imparting recognition, rewards, and or virtual currency.

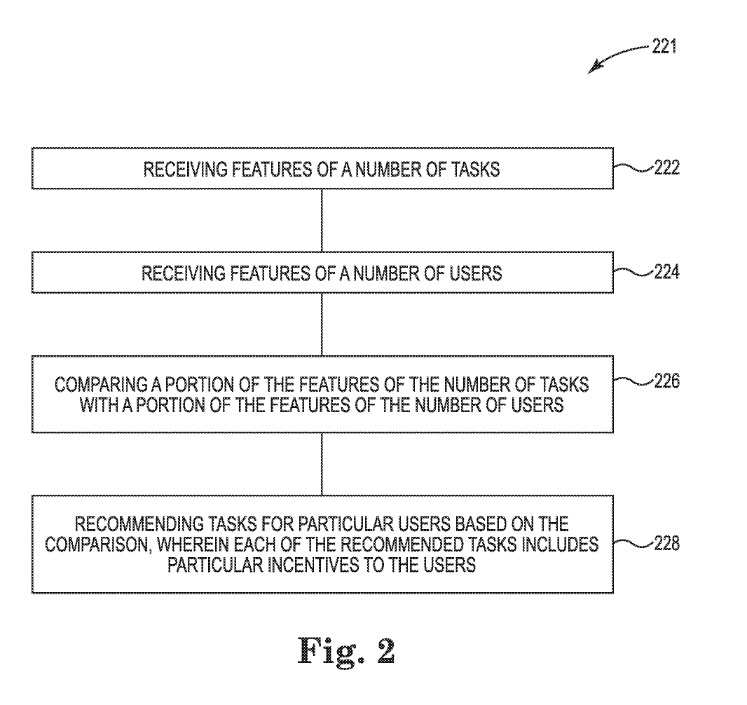

FIG. 2 illustrates a block diagram of an example of a method 221 for crowdsourcing a task within an enterprise according to the present disclosure. At 222 the method 221 includes receiving features of a number of tasks. For example, the number of tasks can include a number of computer programming tasks associated with developing a new software application. Receiving features of a number of tasks can include receiving the features from enterprise resources and/or online resources. For example, at 221 features of a number of tasks can be received from an enterprise database containing tasks input by task creators along with a survey completed by the task creator regarding features of the task. As outlined in greater detail with regard to FIG. 1, the features of the number of tasks can include a description of each task, a list of skills associated with task completion, a level of complexity of each task, the importance of each task, a task deadline, and/or an estimated amount of time to complete each task.

A description of each task within the task features can include a textual description. For example, the textual description can include, but is not limited to, text stating that a particular task is “Writing Code for a User Interface of New Application X.”

A list of skills associated with task completion within the task features can include a listing of skills applicable to completing the particular task. For example, the list of skills can include “JavaScript Programming”. The list of skills associated with task completion can also include a proficiency score in each listed skill. For example, the list of skills may include “JavaScript Programming-Level 3”, where Level 3 indicates, for example, a proficiency in JavaScript Programming equal to three years' experience.

A level of complexity of each task within the task features can include a metric of the difficulty of a given task. The metric can measure the difficulty of the task as against other tasks. For example, a level of complexity of a task can be “Complexity—Level 9.” In this example, the score can be out of a possible 10 levels and a Level 9 score can communicate that this task is in the 90^{th} percentile of complexity. That is, there are, on average, 10% of all tasks that are more complicated than the task with this task feature.

An importance of each task within the task features can include a metric of the value and/or exigency attached to a task. The metric can measure the task as against other tasks. For example, an importance of a task can be “Importance—Level 9.” In this example, the score can be out of a possible 10 levels and a Level 9 score can communicate that this task is in the 90^{th} percentile of importance. That is, there are on average, 10% of all tasks that are more important than the task with this task feature.

A task deadline of each task within the task features can include a deadline by which the task must be completed. For example, a deadline can be “Deadline—June 01”, where June 01 is the date by which the task must be completed.

An estimated amount of time to complete each task within task features can include an estimate of the likely temporal commitment to compete the task. For example, the estimated amount of time to complete can be “Estimated Time to Complete—83 hours,” where 83 hours represents the estimate of the task creator as to how many man-hours could be spent to complete the particular task.

At 224 the method 221 can include receiving features of a number of users. It should be appreciated that a user can be a single individual or multiple individuals. Receiving features of a number of users can include receiving the features from enterprise resources and/or online resources. For example, receiving features of a number of users can include, but is not limited to, receiving user features from an employee database maintained by a human resources department, from users' enterprise email/calendar accounts, and from users' LinkedIn pages.

Detailed in FIG. 1, the features of the number of users can include skill sets of each user, a number of tasks completed by each user, any groups that each user may belong to, and aspects of each user's schedule.

Skill sets of each user within user features can include, but are not limited to, textual descriptions of skills, listings of the skills of a number of skills recognized within the system possessed by the user (which can provide a more standardized skill set listing), and/or any symbols (e.g. colors, numbers, letters, etc.) that communicate a skill. For example, skill sets of a given user can include “JavaScript Programming, C# Programming, and AJAX Programming”. Skill sets can include a proficiency score of each user. The proficiency score can be related a particular skill. For example the proficiency score of a given user can include “JavaScript Programming—Level 3”, where Level 3 indicates, for example, a proficiency in JavaScript Programming equal to three years' experience.

A number of tasks completed by each user can include, but is not limited to the number of tasks created or performed by a given user. For example, the number of tasks completed for a given user can be “Tasks Created—1, Tasks Performed—99.”

Any groups that a user may belong to can include any identification of any organizational unit with which a user identifies himself. These groups can include groups formed by the users based on common interests and skill sets. For example, a report of any groups which a given user belongs to can include “Groups—‘User Interface Specialists’, ‘JavaScript Experts’.”

Aspects of each user's schedules within user features can include, but are not limited to, a full schedule of events, a schedule of availability, a schedule of deadlines the user must meet, and/or an enterprise calendar. For example, aspects of a given user's schedule can include a link to the user's enterprise calendar demonstrating the user's availability to perform tasks for each calendar day.

At 226 the method 221 can include comparing a portion of the features of the number of tasks with a portion of the features of the number of users. Comparing is described in greater detail in the above discussion of FIG. 1. The comparing element 108 can conduct the comparison based on triggers (e.g. events in the system which lead to a comparison request). For example, a user interested in performing a task may cause a search to be executed for active tasks which triggers the comparison of his performer features (e.g. skill set: “JavaScript Programming, C# Programming, and AJAX Programming,” proficiency score: “JavaScript Programming—Level 3, C# Programming—Level 1, and AJAX Programming—Level 3,” number of tasks completed: “Tasks Created—1, Tasks Performed—99,” groups: ‘User Interface Specialists’, ‘JavaScript Experts’,” aspects of schedule “Schedule Open—No tasks scheduled.”) to the creator features (e.g. task creator 1—1 active task, task creator 2—59 active tasks, task creator 3—12 active tasks), the tasks, and/or the task features (e.g. Task 1—“Writing Code for a User Interface of New Application X,” list of skills “JavaScript Programming—Level 3,” “Complexity—Level 9,” “Importance—Level 9,” “Deadline—June 01,” “Estimated Time to Complete—83 hours,” Task 2—“Writing Code for Hardware Driver Y,” list of skills “Python Programming—Level 1,” “Complexity—Level 7,” “Importance—Level 5,” “Deadline—February 14,” “Estimated Time to Complete—67 hours,” Task 3—“Debugging Application Z” list of skills “C# Programming—Level 4,” “Complexity—Level 8,” “Importance—Level 5,” “Deadline—September 10,” “Estimated Time to Complete—71 hours”) of available tasks.

At 228 the method 221 can include recommending tasks for particular users based on the comparison at 226. Recommending tasks based on comparing a portion of the features of a number of tasks with a portion of the features of the number of users is detailed in the above discussion of FIG. 1. Recommending based on the comparison can include recommending a task to a user, and/or a user to a task, based on matches between performer features and creator features, the tasks, and/or the task features. Matches can include increments of identity between any portions of any features. Recommending can include recommending particular tasks and/or task performers. For example, the method 221 at 228 can recommend Task 1 (e.g. Task 1—“Writing Code for a User Interface of New Application X,” list of skills “JavaScript Programming—Level 3,” “Complexity—Level 9,” “Importance—Level 9,” “Deadline—June 01,” “Estimated Time to Complete—83 hours.”) to a User 1 (e.g. User 1—skill set: “JavaScript Programming, C# Programming, and AJAX Programming,” proficiency score: “JavaScript Programming—Level 3, C# Programming—Level 1, and AJAX Programming—Level 3,” number of tasks completed: “Tasks Created—1, Tasks Performed—99,” groups: ‘User Interface Specialists’, ‘JavaScript Experts’,” aspects of schedule “Schedule Open—No tasks scheduled.”) based on matches between performer features and creator features, the tasks, and/or the task features. Each of the recommended tasks of method 221 at 228 can include particular incentive to the users. Incentives can include feedback, credits, tips, rewards, points, gamification measures, user recognition scheme elements, user competition scheme elements, etc.

The method 221 can additionally or alternatively include managing a feedback and credit system. Feedback can include any information about any user action associated with the system 330. For example, feedback can include remarks from other users about the actions of the user who is the subject of the feedback. For example, the remarks may be textual. Alternatively or additionally, feedback can include ratings of the user who is the subject of the feedback. For example, ratings may include textual ratings, binary ratings (e.g. like vs. dislike, good versus bad, etc.), scaled ratings (e.g. ratings from 1 to 10, ratings on an out-of-five-stars rating, etc.), and/or relative ratings (e.g. a number associated with a ranking amongst a list of other users, rankings relative to standard guideline, etc.). The feedback can be general, specific to an action, specific to a task performance, specific to a task creation, related to things ancillary to a specific action, related to a specific user feature, related to the dealings of the user within the system, and/or related to the fairness of the user within the system (e.g. dealing fairly with others). The feedback can be characterized by any text, characters, colors, symbols, etc. Since a user can be any number of users and include groups of users, the feedback can be tailored to individual users, individuals of a number of individuals comprising a user, groups of users, etc. User features can include a number of credits that each of a number of users has earned.

Credits can include a virtual currency. Credits can be transferable between users of the system. Each of the number of users can be provided with a budget of credits, wherein the credits can be exchanged to create a task. To provide each of the number of users with a budget of credits can include allocating credits to a user based on a number of factors. The number of factors can include the users name, rank, position, and/or number of features. Providing a budget of credits can be associated with assigning creation of a task to a task creator by an entity of the enterprise. A budget of credits may be the same for all users or it may differ based on specific features of the user. A budget of credits can be a budget of credits of an individual user, a number of individuals classified as a user, and/or a group of users.

A task, including task features, can be received from the task creator in exchange for a number of credits. Task features can include the amount of credits to create the task and/or the amount of credits transferable to the performer upon performance of the task. Receiving a task and task features can include doing so in exchange for credits. Exchanging credits can include deducting credits from a task creator's budget of credits. The deducted credits can then be held in escrow until the created task is performed. Alternatively and or additionally, the credits may be deducted after the created task is performed. For example, a hold may be placed on the amount of credits necessary to create the task in the task creator's budget of credits and, upon completion of the task, the credits may be deducted from the task creators budget of credits. The amount of credits to create a task can be based on a number of factors. For example, creating a task may cost a flat amount of credits regardless of the task. Alternatively or additionally, an amount of credits to create a task can be based on at least one algorithm that determines the amount based on any number of factors. For example, the amount of credits to create a task may be based on any number of task features associated with the task. Alternatively or additionally, the credits to create a task may be based on a determination by the task creator and/or other entity of the enterprise as to what amount of credits he is willing to pay to a performer of the task.

The method 221 can also include transferring a number of credits from the task creator to the task performer and/or generating credits and transferring the generated credits to the task performer. For example, a number of credits can be deducted from the task creator's budget of credits and added to the task performer's budget of credits. The amount of credits transferred can include the same amount exchanged by the task creator in order to create the task, for example the amount of credits exchanged for receiving the task. The amount of credits transferred can, alternatively, include an amount of credits. For example, the amount of credits transferred and/or generated and transferred can be determined by at least one algorithm that determines an amount of credits to be transferred to a task performer that performed the task based on a number of features of the task.

The amount of credits transferred can include tip credits. Tip credits can include additional credits to the amount to create a task, transferred from the task creator to the task performer based on the performance of the task. For example, if a task performer performs a task well and completes the task in advance of the deadline a task creator may decide to transfer tip credits to the task performer. For example, the task creator may decide the appropriate amount of tip credits based on his judgment, an algorithm which suggests appropriate amounts of tip credit based on task features, and/or any combination of the two. The credits and/or tip credits can be transferred at any time to the task performer including before, after, and during performance of the task. For groups of task performers, the credits and/or tip credits can be transferred to the group of task performers that performed the task. A transfer of credits and/or tip credits to a group can be allocated amongst the group based on any number of group allocation factors. Group allocation factors can include the hierarchy of the group, the amount of work done by each task performer of the group, the allocation preference of the task creator etc. The transferred credits can be used by the recipient to create tasks. For example, the transferred credits can be exchanged to create a task.

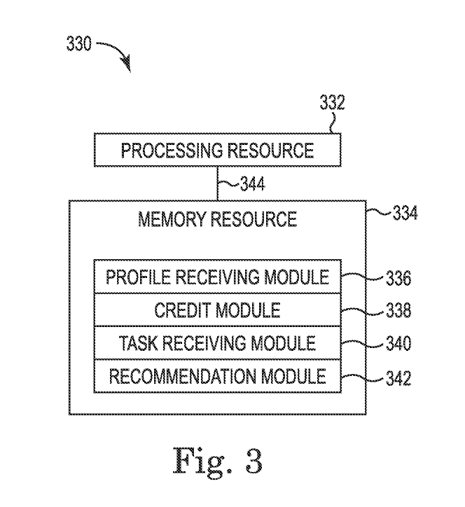

FIG. 3 illustrates a block diagram of an example system for crowdsourcing a task within an enterprise according to the present disclosure. The system 330 can utilize software, hardware, firmware, and/or logic to perform a number of functions (e.g., receive a task that includes a number of task features from a task creator, etc.). The system 330 can utilize software, hardware, firmware, and/or logic to perform any of the functions discussed in regard to FIG. 1 and FIG. 2.

The system 330 can be any combination of hardware and program instructions configured to perform the number of functions. The hardware, for example, can include a processing resource 332. Processing resource 332 may represent any number of processors capable of executing instructions stored by a memory resource (e.g., memory resource 334, machine readable medium, etc.). Processing resource 332 may be integrated in a single device or distributed across devices. The hardware, for example, can alternatively or additionally include a memory resource 334. Memory resource 334 can represent generally any number of memory components capable of storing program instructions (e.g., machine readable instructions (MRI), etc.) that can be executed by processing resource 332. Memory resource 334 can include non-transitory computer readable media. Memory resource 334 may be integrated in a single device or distributed across devices. Further, memory resource 334 may be fully or partially integrated in the same device as processing resource 332 or it may be separate but accessible to that device and processing resource 332. System 330 may be implemented on a user or client device, on a server device or collection of server devices, or on a combination of the user device and the server device or devices.

In one example, the program instructions can be part of an installation package that when installed can be executed by processing resource 332 to implement system 330. In this example, memory resource 334 can be a portable medium such as a CD, DVD, or flash drive or a memory maintained by a server from which the installation package can be downloaded and installed. In another example, the program instructions may be part of an application or applications already installed. Here, memory resource 324 can include integrated memory such as a hard drive, solid state drive, or other integrated memory devices.

The program instructions (e.g., machine-readable instructions (MRI)) can include a number of modules (e.g., 336, 338, 340, and 342) that include MRI executable by the processing resource 332 to execute an intended function (e.g., receive a task that includes a number of features from a task creator, receive profile information that includes a number of user features from a task performer, compare a portion of the number of task features with a portion of the number of user features, provide task information to a task performer based on the comparison, receive the task performer's preference to perform the task, etc.). Each module (e.g., 336, 338, 340, and 342) can be a sub-module of other modules. For example, a profile receiving module 336 and credit module 338 can be sub-modules and/or contained within the task receiving module 340. In another example, the number of modules 336, 338, 340, and 342 can comprise individual modules on separate and distinct computing devices.

A profile receiving module 336 can include machine-readable instructions that when executed by the processing resource 332 can, for example, receive profile information of a number of users. Profile information can include any information associated with a user. For example, profile information can include a number of user features received from, for example, a task performer. Profile information can also or alternatively include feedback on the users. User features can include a number of credits that each of a number of users has earned. Credits can include a virtual currency associated with the system 330. Credits can be transferable between users of the system 330.

A credit module 338 can include machine-readable instructions that when executed by the processing resource 332 can, for example, provide each of the number of users with a budget of credits, wherein the credits can be exchanged to create a task.

A task receiving module 340 can include machine-readable instructions that when executed by the processing resource 332 can, for example, can receive a task that includes a number of task features from a task creator. The task, including task features, can be received from the task creator in exchange for a number of credits. Task features can include the amount of credits to create the task and/or the amount of credits transferable to the performer upon performance of the task. A credit module 338 can include machine-readable instructions that when executed by the processing resource 332 can, for example, exchange credits for a task and task features. The amount of credits to create a task can be based on a number of factors. For example, the amount of credits to create a task can be based on the task features.

A recommendation module 342 can include machine-readable instructions that when executed by the processing resource 332 can, for example, compare the task features with the user features. Comparing can include comparing a portion of the number of task features of tasks with a portion of the number of user features of users. Additionally or alternatively, the recommendation module 342 can include machine-readable instructions that when executed by the processing resource 332 can, for example, provide task information to a task performer based on the comparison. Providing task information to a task performer based on the comparison can include recommending at least one task to a task performer based on the comparison. Task information can include any number of task features. The task performer may then develop a preference to perform a task based on his review of the task features. Furthermore, the recommendation module 342 can include machine-readable instructions that when executed by the processing resource 332 can, for example, recommend at least one task performer to perform the task based on the comparison, wherein to recommend includes to present a portion of the user features of at least one recommended task performer. A recommendation module 342 can include machine-readable instructions that when executed by the processing resource 332 can, for example, receive a user's preference for to perform a task and/or select a performer of a task. For example, receiving a user's preference can include receiving from a task performer a preference to perform a task. Alternatively or additionally, a recommendation module 342 can include machine-readable instructions that when executed by the processing resource 332 can compile a log of a number of task performers from which the preference to perform a task has been received. The log can be any informational compilation which communicates the of task performers from which a preference to perform a task has been received. The log can include a number of user features of each task performer. The number of user features can include the amount of credits for which each task performer is willing to perform the task. Compiling the log can include to provide the log to the task creator to select which of the number of task performers to perform the task.

Alternatively or additionally, a recommendation module 342 can include machine-readable instructions that when executed by the processing resource 332 can, for example, facilitate communication between the task creator and the task performer. Facilitating communication may include any number of communication facilitating means. For example, facilitating communication may include providing an electronic mail system, an instant messaging system, email addresses, telephone numbers, addresses, and/or any contact information for the task creator and/or task performer.

A credit module 338 can include machine-readable instructions that when executed by the processing resource 332 can, for example, transfer a number of credits to a task performer that performed the task. Transferring a number of credits to a task performer can include transferring a number of credits from the task creator to the task performer and/or generating credits and transferring the generated credits to the task performer. For example, a number of credits can be deducted from the task creator's budget of credits and added to the task performer's budget of credits. For groups of task performers, the credits and/or tip credits can be transferred to the group of task performers that performed the task. That is, and task performer can be a group of task performers and the credits can be distributed to the group of task performers that performed the task. A transfer of credits and/or tip credits to a group can be allocated amongst the group based on any number of group allocation factors.

A credit module 338 can include machine-readable instructions that when executed by the processing resource 332 can, alternatively or additionally, manage system-wide user recognition scheme. A recognition system can include rewarding certain activities or frequency of activities with recognition. The user recognition scheme can include incremental recognition tokens assigned to a user based on the user's activity within the system. For example, the recognition tokens can include incrementally higher levels achieved by a user every time the user performs an activity within the system 330. For example a user may achieve a higher level based on performing a task and/or creating a task. Alternatively or additionally, the recognition tokens can include badges which signify a level of recognition within the system 330 based on the user's activity. For example, a user may obtain a new badge by performing a task and/or creating a task. Recognition tokens can further include a peer recognition component. A peer recognition component can include a system-wide leader board which can be formatted to display user activity. For example, a user may be posted on and/or move up on a community leaderboard that displays a number of tasks completed. The system-wide leaderboard may alternatively or additionally be based on features of the tasks created by a user, features of a task performed by a user, features of the user, feedback, credits, tip credits, etc.

A credit module 338 can include machine-readable instructions that when executed by the processing resource 332 can, alternatively or additionally, manage a system-wide competition scheme. A competition scheme can include any number of competitions between users. For example, a competition can be managed that offers a reward to a user for engaging in an activity and/or level of activity. For example, a credit bonus can be offered to a user who completes the highest number of tasks with certain task features within an allotted amount of time. Alternatively or additionally, compensation of the user may be based on the competitions.

The memory resource 334, as described herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), etc., as well as other types of machine-readable media.

The memory resource 334 can be integral and/or communicatively coupled to a computing device in a wired and/or a wireless manner. For example, the memory resource 334 can be an internal memory, a portable memory, a portable disk, and/or a memory associated with another computing resource (e.g., enabling MRIs to be transferred and/or executed across a network such as the Internet).

The memory resource 334 can be in communication with the processing resource 332 via a communication path 344. The communication path 344 can be local or remote to a machine (e.g., a computer) associated with the processing resource 332. Examples of a local communication path 344 can include an electronic bus internal to a machine (e.g., a computer) where the memory resource 334 is one of volatile, non-volatile, fixed, and/or removable storage medium in communication with the processing resource 332 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 344 can be such that the memory resource 334 is remote from the processing resource 332 such as in a network connection between the memory resource 334 and the processing resources (e.g., 332). That is, the communication path 344 can be a network connection. Examples of such a network connection can include a local area network (LAN), a wide area network (WAN), a personal area network (PAN), and the Internet, among others. In such examples, the memory resource 334 can be associated with a first computing device and a processor of the processing resource 332 can be associated with a second computing device (e.g., a Java® server). For example, a processing resource 332 can be in communication with a memory resource 334, where the memory resource 334 includes a set of MRI and where the processing resource 332 is designed to carry out the set of MRI.

As used herein, “logic” is an alternative and/or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

It is to be understood that the descriptions presented herein have been made in an illustrative manner and not a restrictive manner. Although specific examples for systems, methods, computing devices, and instructions have been illustrated and described herein, other equivalent component arrangements, instructions, and/or device logic can be substituted for the specific examples presented herein without departing from the spirit and scope of the present disclosure.

What is claimed:

1. A method of crowdsourcing a task within an enterprise, comprising:
receiving features of a number of tasks;
receiving features of a number of users;
comparing a portion of the features of the number of tasks with a portion of the features of the number of users; and
recommending tasks for particular users based on the comparison, wherein each of the recommended tasks includes particular incentives to the users.

2. The method of claim 1, wherein the features of the number of tasks include a description of each task, a list skills associated with task completion, a level of complexity of each task, the importance of each task, a task deadline, and an estimated amount of time to complete each task.

3. The method of claim 2, wherein the features of the number of tasks include a deadline for each task.

4. The method of claim 1, wherein the features of the number of users include skill sets of each user, a number of tasks completed by each user, groups that each user belongs to, and aspects of each users schedule.

5. The method of claim 4, wherein the skill sets of each user includes a proficiency score of each user within each of the skill sets.

6. The method of claim 1, wherein receiving the features of a number of users includes receiving the features from an enterprise resource and an online resource.

7. A non-transitory machine-readable medium storing a set of instructions that, when executed, cause a processing resource to:
receive a task that includes a number of task features from a task creator;
receive profile information that includes a number of user features from a task performer;
compare a portion of the number of task features with a portion of the number of user features;
provide task information to a task performer based on the comparison; and
receive the task performer's preference to perform the task.

8. The medium of claim 7, comprising instructions that, when executed, cause the processing resource to compile a log of a number of task performers from which the preference to perform the task has been received and provide the log to the task creator to select which of the number of task performers to perform the task.

9. The medium of claim 8, wherein the log includes the number of user features of each task performer.

10. The medium of claim 7, further comprising instructions that, when executed, cause the processing resource to facilitate communication between the task creator and the task performer.

11. A system of crowdsourcing a task within an enterprise, the system comprising:
a processing resource in communication with a memory resource, wherein the memory resource includes a set of instructions and wherein the processing resources is designed to carry out the set of instructions to:
receive profile information of a number of users, wherein the profile information includes user features and feedback on the users;
provide each of the number of users with a budget of credits, wherein the credits can be exchanged to create a task;
receive the task from a task creator in exchange for a number of credits, wherein the task includes task features;
compare the task features with user features;
recommend a task performer to perform the task based on the comparison, wherein to recommend includes to present a portion of the user features of the recommended task performer; and
transfer the number of credits to a task performer that performed the task.

12. The system of claim 11, wherein the user features include a number of credits that each of the number of users has earned.

13. The system of claim 11, wherein any task performer can be a group of task performers and the credits can be distributed to the group of task performers that performed the task.

14. The system of claim 11, wherein an amount of credits to create a task is based on the task features.

15. The system of claim 11, comprising a set of instructions wherein the processing resource is designed to carry out the set of instructions to manage a system-wide user recognition scheme, wherein the scheme includes incremental recognition tokens assigned to a user based on the user's activity within the system.
